(19) United States
(12) Patent Application Publication
(10) Pub. No.: US 2004/0268190 A1
(43) Pub. Date: Dec. 30, 2004

(54) Adjusting parameters of a serial link

(75) Inventors: Marcel A. Kossel, Zurich (CH); Martin Schmatz, Rueschlikon (CH)

Correspondence Address: Louis P. Herzberg, Intellectual Property Law Dept., IBM Corporation, P.O. Box 218, Yorktown Heights, NY, 10598, US

(73) Assignee: International Business Machines Corporation, Armonk, NY

(21) Appl. No.: 10/842,804

(22) Filed: May 11, 2004

(30) Foreign Application Priority Data
May 19, 2003 (EP) 03405341.3

(51) Int. Cl. G06F 11/00

(52) U.S. Cl. 714/704

(57) ABSTRACT

Methods, systems and apparatus for adjusting parameters of a serial link is introduced. A bit pattern sequence that was transmitted via a transmission channel of the serial link is sampled at different sampling times. For the different sampling times, corresponding bit error rate values are determined. The bit error rate values result in a curve. Based on this curve, a quality value derived, that is used for adjusting parameters of an equalizer unit of the serial link.

### TECHNICAL FIELD

The present invention is directed to a method for adjusting parameters of a serial link, and a receiver of such serial link.

### BACKGROUND OF THE INVENTION

Generally, inter-symbol interference (ISI) occurs on serial links due to a bandwidth limitation of the transmission channel. A frequency response of a transmission channel with typical low pass characteristic is shown in FIG. 1. Amplification A=Vₒᵤₜ/Vᵢₙ is illustrated over frequency, where high frequencies are damped in a way typical for such transmission channels. As a result, when sharp edged digital signals are transmitted over a transmission channel 13 as shown in FIG. 2—wherein sharp edges represent high frequencies in the frequency response diagram—a binary sequence BST of digits 010 at the sender 11 might be received as signal RST at the receiver 12 as shown in FIG. 2. The received signal RST is characterized by flattened edges of the “1” digit, these edges intruding into the adjacent bit lengths due to the bandwidth limitation of the transmission channel. Inter-symbol interference typically occurs when the bandwidth of the transmission channel is approximately lower than 0.7 times the bit rate of the transmitted data signal. The inter-symbol interference in turn deteriorates the bit error rate performance of the link. Equalization methods aim to mitigate the inter-symbol interference problems and thus minimize the bit error rate at the receiver in order to establish a reliable transmission.

The quality of a digital data transmission can not only be characterized by the bit error rate of the serial link but can also be characterized by an eye diagram measured with an oscilloscope. An eye diagram is obtained when transmitting a pseudo random bit sequence PRBS and triggering the received data signal on the oscilloscope by a sub-rate of the data clock.

There is a relationship between the eye opening and the bit error rate. Minimizing the bit error rate means maximizing the eye opening at the receiver. In particular, the horizontal eye opening is of interest as this measure is directly related to the non-ideal timing called jitter of the data signal.

According to FIG. 3, an eye diagram is shown that is taken from the end of a transmission channel right before the signal reaches the receiver. This eye diagram results from the transmission of a PRBS7 sequence over a serial link that shows frequency dependent loss and introduces also ISI due to the roll-off of the transmission channel frequency response. When looking at the eye diagram at, it can be observed that the eye crossings—indicated by terms “crossing0” and “crossing1” in FIG. 3—are strongly affected by all the non-idealities that add jitter to the data signal. Jitter in this regard means deviation from the ideal timing. The eye opening—that is the distance indicated by the term ‘eye opening’ in FIG. 3—is decreased and the eye crossings look ‘blurred’.

“Equalization method for high-speed serial links”, disclosed by International Business Machines Corporation in “Research Disclosures”, Volume No. 72, Report No. 453087, pages 72-74, January 2002, presents a serial link including a transmitter, a receiver and a transmission channel between the transmitter and the receiver. The serial link comprises a channel equalizer for equalizing the loss of the channel. The equalizer is realized as programmable filter. Parameters of the filter are updated automatically during operation of the link. An algorithm analyzes the history of the received data bits for determining the filter parameters.

“An Adaptive PAM-4 5 Gb/s Backplane Transceiver in 0.25 um CMOS”, Jeff Sonntag et al., retrieved on the Internet http://web.doe.carleton.ca/courses/˜c97578/topic7&8/Session%2020,%20Muliti%20Gbps%20Sy s%20and%20Cir/20-3.pdf, and accessed on May, 12, 2003, describes a backplane transceiver which uses PAM-4 across typical FR-4 backplanes for distances up to 50 inches through two sets of backplane connectors. The transmitter comprises a self-adaptive equalizer. An update algorithm for updating the parameters of the equalizer is run in the receiver. The parameters are continually updated. The update algorithm is dependent on an error input and a data input.

“Communication Theory Lectures, Section 5 Adaptive Equalization”, John Murphy, Nov. 17, 1997, retrieved on the Internet http:// having a URL completed by:

www.eeng.dcu.ie/˜murphyj/ee4/ee4part5/ee4part5.html,

and accessed on Nov. 25, 2002, shows a tapped line delay filter or a finite-duration impulse response filter for use as an adaptive equalizer, the equalizer being adjusted by a least mean square algorithm.

According to “An Analog Disk Drive Read Channel with EPR4 Performance”, by Asad Abidi, retrieved on the Internet http:// having a URL completed by:

www.ucop.edu/research/micro/97_{—}98/97_{—}002.pdf,

and accessed on May 12, 2003, a decision feedback equalizer is used as a high performance detector in magnetic storage read channels. The filter tap weights are adapted for complying with a minimum mean-square error.

“A 240-Mbps, 1-W CMOS EPRML Read-Channel LSI Chip Using an Interleaved Subranging Pipeline A/D Converter”, Tatsuji Matsuura et al., IEEE Journal of Solid-State Circuits, Vol. 33, No. 11, page 1840-1850, November 1998, shows a read channel for hard-disk drives comprising two pipeline A/D converter channels in parallel with each channel operating a different phase by alternating between the odd and even phases. An offset mismatch can be detected between odd and even channels. Bit error rate degradation due to an offset mismatch is measured as a function of the offset voltage mismatch.

EP 1 231 746 A1 introduces a method of adjusting equalization parameters in a receiver wherein a bit error rate in a data stream is measured from the number of corrected bits in data blocks which have an information section and an error correction section. A predetermined equalization parameter is changed, and the bit error rate is measured again after the change to find out how to change the predetermined equalization parameter until an optimum is reached. When adjusting the threshold value of the receiver, the history of occurring bits preceding the actual sampled bit is taken into consideration in that the amount and direction of adjustment is derived from a look-up table.

Product announcement “Load Modules—40 Gigabit Unframed Bit Error Rate Tester (BERT)”, by IXIA, retrieved on the Internet http// having a URL completed by:

ixiacom.com/products/loadmodules/LM40GBERT.php,

accessed on Nov. 27, 2002, shows a stand alone bit error rate tester for characterizing components. Two ways of analyzing jitter on a serial data input stream can be performed: Eye contour diagrams and bathtub curves can be generated, wherein the eye contour diagram is similar to an eye diagram as seen on a high-speed oscilloscope, except a family of contour curves indicates the eye opening at various BER levels. The bathtub curves depict BER versus sample phase for a specific threshold level.

It would be advantageous to have a comfortable way of equalization for a serial link that can be applied to high speed serial links of 1 Gbit/s and above while maintaining costs and efforts on a low level.

### SUMMARY OF THE INVENTION

According to one aspect of the invention, there is provided a method for adjusting parameters of a serial link, wherein a bit pattern sequence is received from a transmission channel of the serial link. The bit pattern sequence is sampled at different sampling times. Bit error rate values are determined for the different sampling times, the bit error rate values resulting in a curve. A quality value is derived from the curve and the quality value is used for adjusting parameters of an equalization unit. According to the method, the received bit pattern sequence is sampled at different sampling times across an unit interval. An unit interval is understood as the length of one information unit which might for example be a bit. Within such an unit interval, the sampling time is varied and for different sampling times corresponding bit error rates are determined.

In another aspect of the present invention, there is provided a serial link comprising a sender, a receiver and a transmission channel. The sender comprises a bit pattern sequence generator for generating a bit pattern sequence. The bit pattern sequence is transmitted via the transmission channel to the receiver. The receiver comprises a sampling unit for sampling a received bit pattern sequence, a phase rotator for defining a sampling time, and an error detection unit for determining a bit error rate value for an associated sampling time. A control unit is provided for making the phase rotator sweep the sampling time across a unit interval and causing the error detection unit to determine bit error rate values for different sampling times. An evaluation unit is provided for determining a quality value, the quality value being derived from a curve, the curve being determined by the bit error rate values. The quality value is used at least in an indirect way for adjusting parameters of an equalizer unit, which comprises also the first time adjustment of such parameters. In another advantageous embodiment, the evaluation unit comprises a trigger unit that is configured for causing a particular set of parameters to be applied at the equalizer unit for a data transmission phase, the particular set of parameters being associated to the preferred quality value.

According to another aspect of the invention, there is provided an multiple serial link apparatus with many transmission channels in parallel and associated sender and receiver modules, wherein each receiver at least comprises an individual sampling unit, an individual phase rotator, an individual error detection unit, and an individual equalizer unit. However, the control unit and/or the evaluation unit and/or the bit pattern sequence generator can be shared amongst the serial links and thus be implemented only once for such a multiple serial link apparatus.

According to another aspect of the present invention, there is provided a receiver of a serial link, the receiver comprising features according to the receiver as described for the serial link.

### BRIEF DESCRIPTION OF THE DRAWINGS

The invention and its embodiments will be more fully appreciated by reference to the following detailed description of presently advantageous but nonetheless illustrative embodiments in accordance with the present invention when taken in conjunction with the accompanying drawings, in which:

FIG. 1 a chart showing the frequency response of a transmission channel,

FIG. 2 a block diagram of a serial link according to prior art,

FIG. 3 an eye diagram in connection with data transmission on a serial link,

FIG. 4 a block diagram of a serial link according to an embodiment of the present invention,

FIG. 5 a bathtub curve as a provisional result of a method for adjusting parameters of a serial link in accordance with an embodiment of the invention,

FIG. 6 an illustration of a jitter model,

FIG. 7 another bathtub curve,

FIG. 8 a block diagram of a serial link, according to another embodiment of the present invention, and

FIG. 9 a block diagram of a clock-data-recovery loop that is part of the serial link according to FIG. 8.

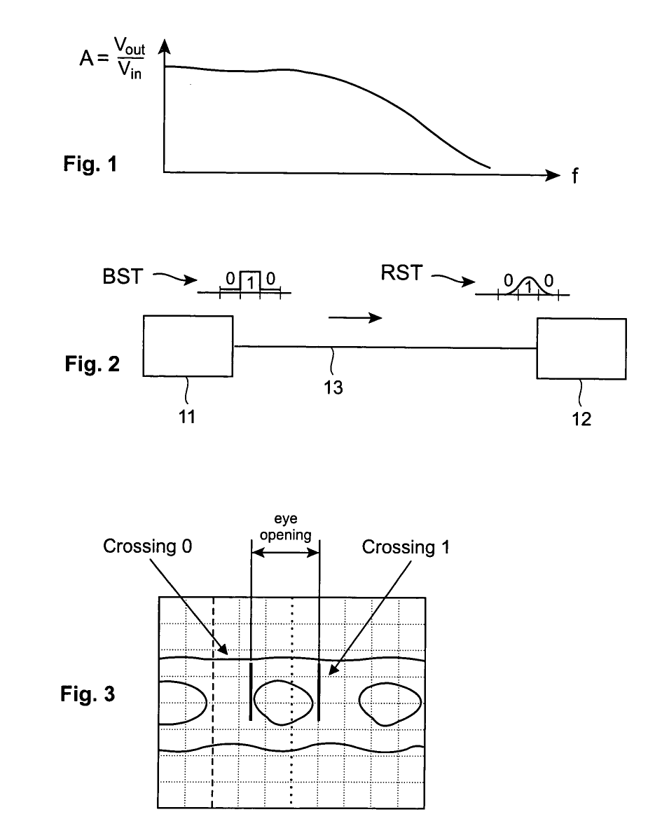

Different figures may contain identical references, representing elements with similar or uniform content.

REFERENCES

| | |
|---|---|
| 1 | serial link |

| | |
|---|---|
| 11 | sender |

| | |
|---|---|
| 111 | bit pattern sequence generator |
| 112 | equalizer unit |
| 113 | OR-Gate |
| 114 | serializer unit |

| | |
|---|---|
| 12 | receiver |

| | |
|---|---|
| 121 | sampling unit |
| 122 | phase rotator |
| 123 | error detection unit |
| 124 | control unit |
| 125 | evaluation unit |
| 126 | trigger unit |
| 127 | deserializer unit |
| 128 | correlator |
| 129 | meta stability pipeline |
| 13 | transmission channel |
| 14 | back channel |

| | |
|---|---|
| BPS | bit pattern sequence |
| BERV | bit error rate value |
| QV | quality value |
| P | parameters |
| PQV | preferred quality value |
| UI | unit interval |

### DETAILED DESCRIPTION OF THE INVENTION

The present invention provides methods, systems and apparatus for adjusting parameters of a serial link, wherein a bit pattern sequence is received from a transmission channel of the serial link. The bit pattern sequence is sampled at different sampling times. Bit error rate values are determined for the different sampling times, the bit error rate values resulting in a curve. A quality value is derived from the curve and the quality value is used for adjusting parameters of an equalization unit.

With respect to the invention, a serial link typically comprises a sender, a receiver, and a transmission channel between the sender and the receiver for transmitting data in a serial way from the sender to the receiver. In order to reconstruct transmitted information, the received bit pattern sequence is typically sampled in an operating mode at a predefined sampling time per unit interval. However, in a present method for adjusting parameters of the serial link in order to achieve low bit error rates, these parameters are advantageously adjusted during an initialization phase. However, the method can also be carried out during an operating mode of the serial link.

According to an example of the method, the received bit pattern sequence is sampled at different sampling times across an unit interval. An unit interval is understood as the length of one information unit which might for example be a bit. Within such an unit interval, the sampling time is varied and for different sampling times corresponding bit error rates are determined. The sampling of the bit pattern sequence at different sampling times and/or the determination of bit error rate values at different sampling times of an unit interval and/or the generation of an associated curve and/or the determination of the quality value by means of this curve can advantageously be performed in the receiver. Whenever at least the bit pattern sequence is sampled in the receiver, advantageously by means of the same sampler that samples input data for further data processing, the data sampled for adjusting the sender parameters are extracted at a location where also the real data are sampled. By making use of the automatic determination of bit error rates at different sampling times of a known bit pattern sequence, the quality value can—again automatically—be determined very quickly, which helps to select parameter settings and might also be beneficial for automatically adjusting a great number of parallel serial links. It depends on the resolution of the quality value and on the resolution of the phase rotator how many bit error rates should be sampled at different sampling times. In an advantageous embodiment, at least three of such bit error values are sampled in order to make reasonable assessments based on the curve characteristics that are determined by these bit error values, and additionally be supported by interpolation.

The parameter settings are settings for an equalizer unit that is parametered in order to evoke optimized bit error rates at the receiver. The equalizer unit is advantageously used for equalizing the loss of the channel. The equalizer unit can be arranged in the sender between the bit pattern sequence generator and the transmission channel such that data and/or the generated random sequences have to pass the equalizer unit, or can be arranged right in the receiver right at the beginning and receives its input from the transmission channel.

By applying the method, jitter can be minimized and the eye opening maximized. This method is crucial for adjusting parameter settings of high speed serial links of 1 Gbit/sec and above, since the quality value derived is directly based on the performance (jitter compression capability) of the receiver core (sampler, clock-data-recovery) itself and not only on the signal quality at the end of the transmission channel. Since the receiver front-end such as connectors or pre-amplifiers also contributes to the channel non-ideality and might introduce additional inter-symbol interference, it is advantageous to take these impacts into account which is in particular crucial when the link is a high speed link. This all is achieved by only little overhead in complexity. As the equalization method is based on bit error rate measurements, the quality of the equalization is better than relying on some eye measurement, as the bit error rate measurements also reflect long-term impacts as a statistical significance of the measured bit errors is required.

Advantageously, quality values associated to different sets of equalizer parameters are determined. A preferred quality value out of the determined quality values is determined. The set of equalizer parameters that is associated to this preferred quality value can then be considered as the preferred set that evokes optimum bit error rates. This preferred set can then be adjusted and used for a data transmission phase in order to optimize the transmission of data following the presently described initialization phase. The more precise the parameters can be adjusted, the longer the transmission channel can be implemented.

Advantageously, the curve generated by the bit error rate values shows bathtub characteristics. Based on this type of curve, it is advantageous that the quality value that basically reflects the fit of the associated equalizer parameter settings in terms of a reduced bit error rate is represented by a horizontal distance between the falling sections of the bathtub curve at a predetermined error rate value. The determination of the quality value can be achieved by computational means. Again, when focusing on optimizing time consumption for finding the best parameters, it is advantageous to measure bit error values at in a range of 3 to 15 different sampling times, advantageously around a sampling time region where the falling sections of the bathtub curve are expected. As can be derived here from, the interpretation of the term curve is not limited to a curve showing a predefined resolution, or a curve extending over the entire unit interval. Sections of the unit interval can also be covered only with a small amount of determined bit error values, and nevertheless result in a curve that allows to derive a quality value. However, when focusing on optimizing the quality value, the bathtub curve should be determined in general by a number of measurements points that reflect a sufficiently well statistical confidence, and in particular by more than 10 bit error values.

In a particular advantageous embodiment, the samples are taken directly on a receiver's chip, and thus at a far better location in terms of extracting representing sample values than any external access point could provide. By implementing this function directly on the receiver's chip, there is provided no misappropriate point of access since the measurements having impact on the bit error rate via selecting the right parameter settings are exactly taken where a bit pattern sequence is sampled also in the data transmission phase, and that is in the receiver chip. Other points of access, e.g. the physical interface between the transmission channel and the receiver would not deliver such accurate results in evaluating the impact of parameter settings on the sampling quality of the received bit pattern sequence since there would be still a distance for the bit pattern sequence to travel from such physical interface to the sampling unit on the chip which distance might be exposed to some more jitter or other effects. Moreover, such a physical interface might not even be accessible—e.g. by a conventional oscilloscope—when the number of channels is very high and the physical I/O is not accessible, e.g. where the single chips are arranged within a ball-grid array (BGA) package.

In another advantageous embodiment, the bit error rate values and/or the quality value are determined by a corresponding function implemented on a receiver's chip. This enables the proposed method to be implemented in a most compact way.

With the present invention, there is also provided a serial link comprising a sender, a receiver and a transmission channel. The sender comprises a bit pattern sequence generator for generating a bit pattern sequence. The bit pattern sequence is transmitted via the transmission channel to the receiver. The receiver comprises a sampling unit for sampling a received bit pattern sequence, a phase rotator for defining a sampling time, and an error detection unit for determining a bit error rate value for an associated sampling time. A control unit is provided for making the phase rotator sweep the sampling time across a unit interval and causing the error detection unit to determine bit error rate values for different sampling times. An evaluation unit is provided for determining a quality value, the quality value being derived from a curve, the curve being determined by the bit error rate values. The quality value is used at least in an indirect way for adjusting parameters of an equalizer unit, which comprises also the first time adjustment of such parameters. In case the equalizer unit is located at the sender side, it is advantageous to install a back channel from the receiver to the sender. Advantageously, the evaluation unit is designed for determining a preferred quality value out of a plurality of quality values, each quality value being associated to a different set of parameters at the equalizer unit.

In another advantageous embodiment, the evaluation unit comprises a trigger unit that is configured for causing a particular set of parameters to be applied at the equalizer unit for a data transmission phase, the particular set of parameters being associated to the preferred quality value.

Advantageously, the sampling unit and the phase rotator are arranged on a receiver's chip, as well as the error detection unit and/or the control unit and/or the evaluation unit can be in another advantageous embodiment. Control unit and/or evaluation unit are preferably integrated into the receiver.

There is also provided an multiple serial link apparatus with many transmission channels in parallel and associated sender and receiver modules, wherein each receiver at least comprises an individual sampling unit, an individual phase rotator, an individual error detection unit, and an individual equalizer unit. However, the control unit and/or the evaluation unit and/or the bit pattern sequence generator can be shared amongst the serial links and thus be implemented only once for such a multiple serial link apparatus.

This aspect of the invention also tackles the problem of optimizing link parameters of a multiple link apparatus which might include a very large number of parallel serial links. In particular with such apparatus, an automatically parameter adjustment for each channel is beneficial with regard to time, costs and efforts, especially when certain components can be jointly used by several channels.

In the present invention, there is also provided a receiver of a serial link. The receiver comprising features according to the receiver described fot the serial link. It is to be understood that, in general where features are described herein with reference to a method embodying the invention, corresponding features may be provided in accordance with apparatus embodying the invention, and vice versa.

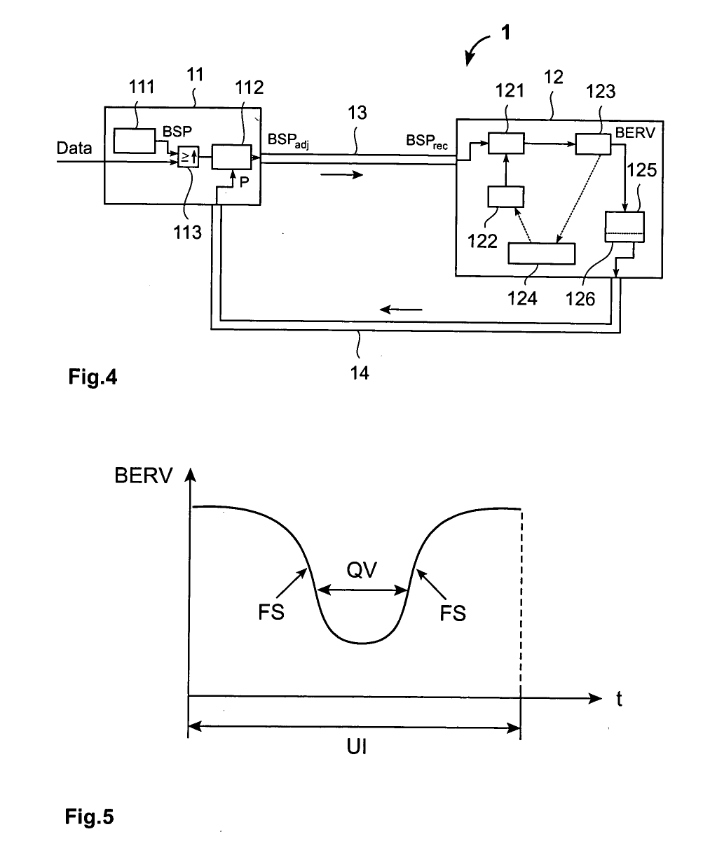

FIG. 4 shows a block diagram of a serial link 1 in accordance with an embodiment of the present invention. The serial link 1 comprises a sender 11, a receiver 12, a transmission channel 13, and a back channel 14. The transmission channel 13 used in such a serial link application might be typically a single wire, a differential wire pair or an optical channel including laser driver and photo receiver. All of these channels show frequency dependent loss. If a bit stream is transmitted over a channel with frequency dependent loss, then the signal waveform at the receiver shows inter-symbol interference that can significantly close the eye opening. Tight time margins with increased bit error rates are a result of that.

The sender 11 includes a pre-emphasis unit 112, which is a block that should have a frequency dependent gain curve representing the inverse of the loss of the transmission channel 13, canceling the adverse channel effects. The term pre-emphasis unit is used as another term for the term “equalizer unit” in the following. If a signal passes through both the transmission channel 13 and the pre-emphasis unit 112, the resulting signal shows no frequency dependent loss anymore, and the unwanted inter-symbol interference is reduced to zero in the ideal case. The pre-emphasis unit 112 can also be called predistortion filter.

The pre-emphasis unit 112 comprises an input for setting parameters P. The parameters can also be called coefficients or weights. By means of these parameters P, the frequency dependent gain curve of the pre-emphasis unit 112 is adjusted. In particular, the pre-emphasis unit 112 can be a programmable finite impulse response (FIR) filter having a characteristic such as Vₒᵤₜ=c0*Vᵢₙ₁+c1*Vᵢₙ₂+ . . . , with c0, c1 as adjustable parameters of the pre-emphasis unit.

In order to transmit a pulse via a transmission channel 13 showing a frequency dependent loss in particular at high frequencies, the pre-emphasis unit 13 has to be programmed by parameters such that the initial part of the pulse to be transmitted might be amplified in order to amplify in particular high frequencies characterized by edges of a pulse or vice versa damp the amplitude of low frequency components. By applying the right parameters to the pre-emphasis unit, the joint frequency response of the pre-emphasis unit and the transmission channel can nearly be provoked to show a constant loss over the frequencies of interest.

The sender 11 further comprises a bit pattern sequence generator 11 for generating bit pattern sequences BSP. The fact that the generator is called bit pattern generator does not limit its mode of operation to generate binary digits: Dependent on the way of coding that is used, the bit pattern generator 111 might also provide multilevel patterns or whatever reference signal is needed. In particular, a so called PRBS7 bit pattern sequence is generated and applied during the initialization phase, which PRBS7 bit pattern sequence comprises a defined sequence of 127 bits with around the same number of “0” digits as the number of “1” digits, and which is transmitted repeatedly. The PRBS7 sequence is generated by means of a feedback shift register. Such feedback shift register is also used on the receiver's side for receiving the PRBS7 sequence. These registers are not shown in detail in FIG. 4. In general, every pseudo random bit sequence can be transmitted, as long as this sequence is known at the receiver.

The sender 11 is embodied such that either the bit pattern sequence generator 111 might provide the pre-emphasis unit 112 with a bit pattern sequence BSP, or (implemented by an OR gate 113) with data. The pre-emphasis unit 112 provides the transmission channel with a bit pattern sequence BSP_{adj}adjusted by the pre-emphasis unit 112.

In the receiver 12, a sampling unit 121 is provided for sampling a received bit pattern sequence BSP_{rec}. However, the sampling phase is not fixed to a predefined value, but is adjustable by means of a phase rotator 122. The phase rotator is controlled by a control unit 124. A bit error detection unit 122 is provided for determining a bit error value for the sampling time that is given by the phase rotator unit 122, respectively controlled by the control unit 124. The bit error rate or bit error rate value BERV is typically defined as ratio of bits classified as not being transmitted correctly in relation to the overall bits transmitted via the transmission channel 13. An error is usually detected when the received bit does not show the same digit as the original bit. Therefore, the received bits are compared to a threshold in order to determine the digit the bit represents. As the bit pattern sequence that is emitted by the bit pattern sequence generator 111 is known by the receiver 12, the receiver 12 is able to detect error bits in the received bit pattern sequence.

Once the error detection unit 122 has collected sufficient data for determining the bit error rate value BERV for the associated sampling time, the bit error rate value BERV which represents a probability for a bit error rate when sampling at the associated sampling time is forwarded to an evaluation unit 125; It is also indicated to the control unit 124, that the determination of a bit error rate value BERV is concluded. When having received such note from the error detection unit 122, the control unit 124 makes the phase rotator 122 adjust a different sampling time. Afterwards, the bit pattern sequence as received is sampled by the sampling unit 121 at the different sampling time within an unit interval which is considered as a bit length.

By determining the bit error rate values BERV for different sampling times, the evaluation unit 125 is enabled to collect the various bit error rate values BERV which result in a curve. The curve shows the bit error values BERV over different sampling times within an unit interval UI. An example of such curve is shown in FIG. 5. The curve typically shows bathtub characteristics. A bathtub curve can be characterized by two falling sections FS in a middle section of the unit interval, each falling section falling from a high bit error rate level on the edges of the unit interval. The basic interpretation of such bathtub curve is that the lowest bit error rate values are achieved when the received signal is sampled at a timing phase that corresponds to the minimum of the bathtub curve, which might be located e.g. around the middle of an unit interval. This information, and in particular more detailed information with regard to the optimum sampling time can be used for adjusting such optimum sampling time for sampling received data in the operation mode of the serial link.

However, according to the embodiment of the invention, different bathtub curves can be generated where each of such a bathtub curve is associated to different sets of parameters at the pre-emphasis unit 112 of sender 11. When determining different bathtub curves, these bathtub curves are evaluated according to one or more criteria. At least one criteria which is called a quality value QV in the following is determined by the evaluation unit 125. A preferred criteria is the horizontal distance between the two falling section FS of a bathtub curve at a defined bit error rate value BERV as shown in FIG. 5. This horizontal distance is advantageously used as quality value QV which is compared with the quality values of different bathtub curves associated to different parameter settings. Additional or different quality values can be applied. The quality value corresponds in principle to a horizontal eye opening at a specified bit error rate. However, note that the bit error rate information is not explicitly available when measuring eye diagrams with an oscilloscope.

With regard to the horizontal distance taken as a quality value as explained above, it is advantageous to generate a large distance at the defined bit error rate value as preferred quality value PQV associated to a particular parameter setting of the pre-emphasis unit 112. The larger the horizontal distance is, the more sampling times offer a low bit error rate value. This is why the horizontal distance is advantageously taken as a quality measure for assessing the impact of different parameter settings. It is advantageous to determine the horizontal distance at a low bit error rate value, e.g. at a rate of 10⁻¹⁰ or less. When taking the horizontal distance on a higher bit error rate values, the statistical significance decreases. an advantageous range to select the bit error rate value for determining the horizontal distance is between 10⁻¹⁰ and 10⁻¹⁴. In particular, a bit error rate value of 10⁻¹² is advantageous for determining the quality value.

Another quality value could be the gradient of the falling sections FS. The higher the gradient, the more preferred the set of parameters is as a low gradient typically covers a large area of the unit interval with relatively high valued bit error rates.

In order to determine an optimum parameter setting, an iterative process for determining the preferred quality value can be performed including the determination of different quality values associated to different parameter settings, and determining the preferred quality value in the end.

There might be different ways how the iteration can be implemented. The evaluation unit 125 or the receiver 12 in general might trigger the pre-emphasis unit 112 to load different parameter settings via the back channel 14 whenever a quality value could be derived in the receiver. In this embodiment, the sender 11 would have stored different parameter settings to be applied to the pre-emphasis unit subsequently. In another way of operation, the receiver might even transmit new sets of parameters to be adjusted at the pre-emphasis unit 112, using the back channel as media for transmission. The parameters may be multiplexed on a single wire/channel back channel 14. The parameters may also be transmitted each on a dedicated wire/channel. In another embodiment, the settings at the pre-emphasis unit 112 are changed on a regular basis with a frequency which gives the receiver 12 enough time to determine a quality value for each setting. In this embodiment, the back channel is only used for announcing the preferred quality value to the sender.

The parameters can be adapted automatically during the during system initialization or in the background during normal operation of the link. Advantageously, all the units 121, 122, 123, 124 and 125 are implemented on-chip on a receiver's chip. Advantageously, the units 121, 122, 123 and 124 are implemented on-chip. In another advantageous embodiment, the units 121, 122 and 123 are implemented on-chip.

It is advantageous to use the same sampling unit 121 for determining the bit error rate values BERV that is also used for sampling data in the operation mode of the serial link. Such sampling unit is advantageously implemented on-chip. Then, the bit error rate values do have significance on the error rates the data signal will suffer as sampled at exactly at the same location. All other noise and/or channel limitation is included and taken into consideration when determining the optimum set of parameters to be applied to the pre-emphasis unit, such as the noise of the receiver's phase locked loop, as well as noise introduced at the connector between transmission channel and the receiver.

In general, it is not only the transmission channel specific loss that can be compensated by the pre-emphasis unit provided the right parameter settings are chosen. All other effects having impact on the frequency response such as aging, temperature drift, power supply changes, or varying channel specific loss can be compensated. These benefits are achieved in combination with only a small chip area needed in the receiver, and in combination with only low power consumption (<=10 mW/Gbit/s).

According to another embodiment of the invention, the evaluation unit may be implemented outside the receiver's chip and outside the receiver, and may be implemented on a computer.

The invention is applicable to high speed links having high data rates>5 Gbit/s. Such serial links might be embodied as chip-to-chip links, or as links between backplanes, etc.

The following section reflects a mathematical approach to the invention. It is of interest how jitter affects the bit error rate performance of the serial link. This approach is based on scanning the bit error rate within an data eye. The measured bit error rates result in a curve. This curve is fitted into a mathematical jitter model to obtain the jitter properties.

In general, jitter can be split into random and deterministic components. Random jitter is characterized by a Gaussian distribution and stems, for instance, from VCO phase noise or power-supply noise. The probability density function PDF of random jitter RJ is given by:

$${PDF}_{RJ} = \frac{1}{\sqrt{2 π } {σ}_{RJ}} exp ( - \frac{{t}^{2}}{2 {σ}_{RJ}} ) . \qquad ( 1 )$$

The standard deviation σ_{RJ} is also referred to as jitter number RJ, and describes the jitter contribution of all random processes in the serial link. Note that random jitter is of Gaussian nature and is not bounded in amplitude. Thus random jitter RJ is given as root-mean-square value rms.

Deterministic jitter is further subdivided into different categories according to its origin. Predominant kinds of deterministic jitter are sinusoidal and data-dependent jitter as well as jitter arising from duty-cycle distortion. Sinusoidal jitter can stem from slow variations of the supply voltage, the temperature, or the clock reference. It is modeled by a sinusoidal single frequency jitter component, with the jitter number SJ being the jitter amplitude at the given frequency. Deterministic jitter due to intersymbol-interference ISI or duty-cycle distortion is also bounded in amplitude by a peak-to-peak value but shows different density functions. As the true density function is generally not known, the probability density function PDF for these kinds of deterministic jitter is approximated by a dual Dirac function, where the density function is assumed to be comprised only of a pair of delta functions:

$${PDF}_{DJ} = \frac{1}{2} δ ( t - \frac{DJ}{2} ) + \frac{1}{2} δ ( t + \frac{DJ}{2} ) . \qquad ( 2 )$$

Each delta function is offset from the mean crossing position by half the peak value of the jitter number DJ. The kinds of deterministic jitter described differ not only by their PDFs but also by their frequency spectral characteristics. Whereas sinusoidal jitter typically represents low-frequency jitter, all other deterministic jitter is high-frequency. Low-frequency jitter is not that much of a problem in high-speed serial links as the clock-data-recovery (CDR) receiver is capable of tracking jitter with frequency contents lying within its loop bandwidth. The low-frequency jitter tracking capability of the CDR receiver requires that the overlaying protocol function must have sufficient storage capacity to handle the additional delay. As only high-frequency deterministic jitter is detrimental to the link's bit error rate BER performance, sinusoidal jitter will therefore not be considered in the jitter model discussed below.

When adding contributions from different random variables, their density functions will be convoluted. The total PDF related to the first zero crossing of the eye according to FIG. 3 is thus given by the convolution of the random jitter PDF and the deterministic jitter PDF:

$$\begin{matrix}{PDF}_{crossing0} = \frac{1}{\sqrt{2 π} RJ} exp ( - \frac{{t}^{2}}{2 RJ} ) ⊗ \{ \frac{1}{2} δ ( t - \frac{DJ}{2} ) + \frac{1}{2} δ ( t + \frac{DJ}{2} ) \} \\ = \frac{1}{2 \sqrt{2 π} RJ} ( exp ( - \frac{{( t - DJ / 2 )}^{2}}{2 RJ} ) + exp ( - \frac{{( t + DJ / 2 )}^{2}}{2 RJ} ) ) .\end{matrix} \qquad ( 3 )$$

The same relationship holds for the second zero crossing—but maybe with other values for DJ and RJ. The fact that there could be different values for the jitter numbers of the left- and right-hand-side zero crossings is not allowed for in the following computations but can easily be implemented by introducing a kind of effective jitter number that equals the mean value of the jitter numbers for both zero crossings.

To calculate the probability of error due to jitter, the area under the PDF tail on the error side of the sampling point must be calculated. This yields the cumulative distribution function CDF. For instance, for the left-hand-side zero crossing0, the integration is carried out from the sampling point to +∞:

$$\begin{matrix}{CDF}_{crossing0} = {\int }_{t}^{∞} {PDF}_{crossing0} ⅆ t \\ = \frac{1}{4} ( 2 + erf ( \frac{t - DJ / 2}{\sqrt{2} RJ} ) + erf ( \frac{t + DJ / 2}{\sqrt{2} RJ} ) )\end{matrix} \qquad ( 4 )$$

where erf( ) denotes the error function. To determine the bit error rate, the probability of transition error, which is identical to the CDF function, must be multiplied by the transition probabilities pₜᵣₐₙₛ (e.g. pₜᵣₐₙₛ=0.496 for PRBS7, pₜᵣₐₙₛ=number of ones/(2⁷ bits−1)=63/127). The contributions to the bit error rate from both zero crossings are then added:

BER=P_{biterror}=pₜᵣₐₙₛ·CDF_{crossing0}+(1−pₜᵣₐₙₛ)·CDF_{crossing1} (5)

Equation (5) describes the jitter model used for the bit error rate test scan technique mathematically. In a bit error rate scan, the bit error rate is measured as the sampling point is swept between the two zero crossings. The resulting bit error rate curve is a bathtub curve, and corresponds to the formula given by equation (5). The measured bathtub curve and the bathtub curve obtained from the jitter model can now be fitted to obtain the desired jitter numbers. The curve-fitting procedure is quite simple as deterministic jitter DJ only shifts the bathtub curve in horizontal direction and random jitter RJ only affects the steepness of the bathtub curve edges. With regard to the eye diagram presented in FIG. 3, the RJ number determines the ‘thickness’ of the bell curves and the DJ number determines the overlapping distance between the bell curves at each eye crossing.

The accuracy of the bathtub curve fit decreases towards very high and very low bit error rate values. For the former, significant deviations from the assumed curve fit shape can be observed owing to a wrong signal conditioning due to, for instance, overshoot or undershoot effects. For the latter, the accuracy might deteriorate if too short a measurement time is chosen for the bit error rate value targeted.

The bathtub curve fit yields jitter numbers that characterize the properties of jitter appropriately. These jitter numbers also allow the determination of the horizontal eye opening for a specific bit error rate boundary. This is done by calculating the total jitter, which will be discussed in more detail in the following.

Random and deterministic jitter accumulate differently in a serial link. Whereas deterministic jitter is always specified by a peak-to-peak value, random jitter is given by an rms value, which must first be translated into a peak-to-peak value prior to adding random and deterministic jitter values. The translation from RJᵣₘₛ to RJₚ₋ₚ is dependent on the BER boundary considered and can be written as

RJₚ₋ₚ=k_{σ}·RJᵣₘₛ (6)

where k_{σ} denotes a factor associated to different bit error rate boundaries given in Table I.

TABLE I
Multiplication factors for the translation from RJᵣₘₛ to RJₚ₋ₚ

| BER | k_{σ} |
|---|---|
| 1e−4 | 7.08 |
| 1e−5 | 8.22 |
| 1e−6 | 9.22 |
| 1e−7 | 10.14 |
| 1e−8 | 10.98 |
| 1e−9 | 11.77 |
| 1e−10 | 12.51 |
| 1e−11 | 13.21 |
| 1e−12 | 13.88 |
| 1e−13 | 14.51 |
| 1e−14 | 15.13 |
| 1e−15 | 15.71 |
| 1e−16 | 16.29 |
| 1e−17 | 16.75 |

The table entries were computed numerically by solving equation (5) for RJs with different BER values and DJ=0. Table I also allows RJₚ₋ₚ to be specified for the bit error rate extrapolated to very low values (e.g. <10⁻¹⁴) that could not be measured owing to measurement time restrictions. Once RJₚ₋ₚ has been calculated for a specific bit error rate value, the total jitter TJ associated with this BER is easily determined by

TJ=DJ+RJₚ₋ₚ=DJ+k_{σ}·RJᵣₘₛ (7)

Total jitter can be expressed in absolute time units, such as ps, or relative to the nominal bit period in units of the unit interval UI. One UI corresponds to one nominal bit length. If TJ is given in UI, the horizontal eye opening in percent can be stated as

Horizontal Eye Opening [%]=(1−TJ) %*100%. (8)

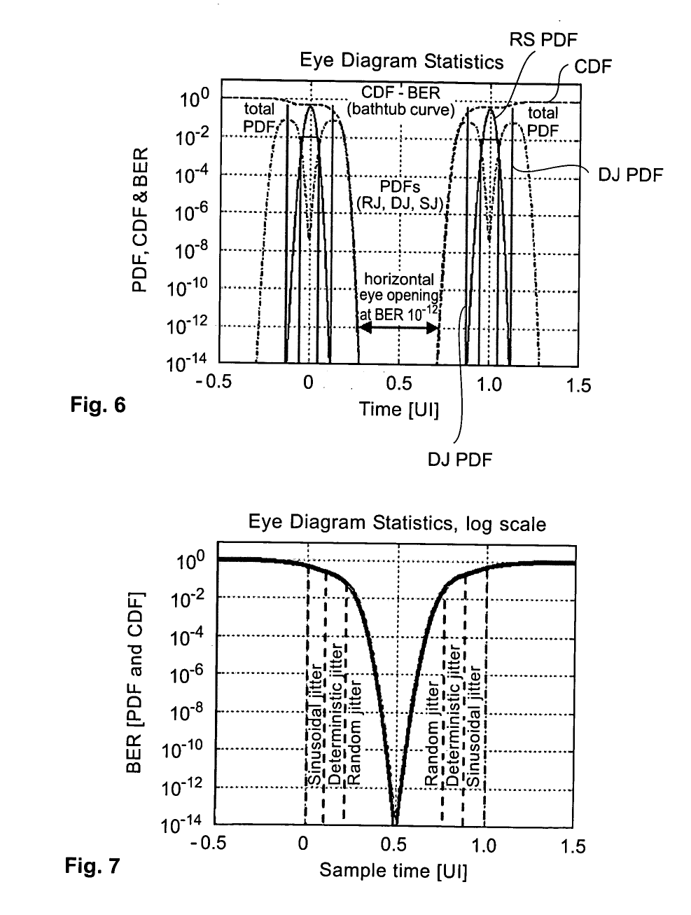

FIG. 6 illustrates the jitter model: The solid curves represent the individual PDFs of the random, deterministic, and sinusoidal jitter components. The total PDF (dash-dotted curve) equals the convolution of the RJ, DJ and SJ PDF. The cumulative distribution function (dashed curve) of the total PDF will be fitted to the measured bathtub curve. Note that, prior to performing the bathtub curve fit, the CDF must be multiplied by the transition probabilities. The jitter numbers associated with the PDFs displayed are RJ=0.015 UI, DJ=0.2 UI and SJ=0.1 UI. For the sake of completeness, all jitter components are used in this embodiment, although SJ can be disregarded for measurements of serial links that are able to track low-frequency jitter.

FIG. 7 shows a bathtub curve that is subdivided into regions where the jitter components specified predominantly affect the curve shape.

The idea of this proposed equalization embodiment is to record the fitted RJ and DJ numbers for each setting of the FIR tap weight which determines the level of pre-emphasis for the equalization, and to find the RJ/DJ pair with the largest eye opening which in turn determines the best FIR tap setting. The largest eye opening occurs where the sum of RJ and DJ is lowest. Note that for data transmission over high-speed serial links the horizontal eye opening is more important than the vertical eye opening as the signal power is not an issue.

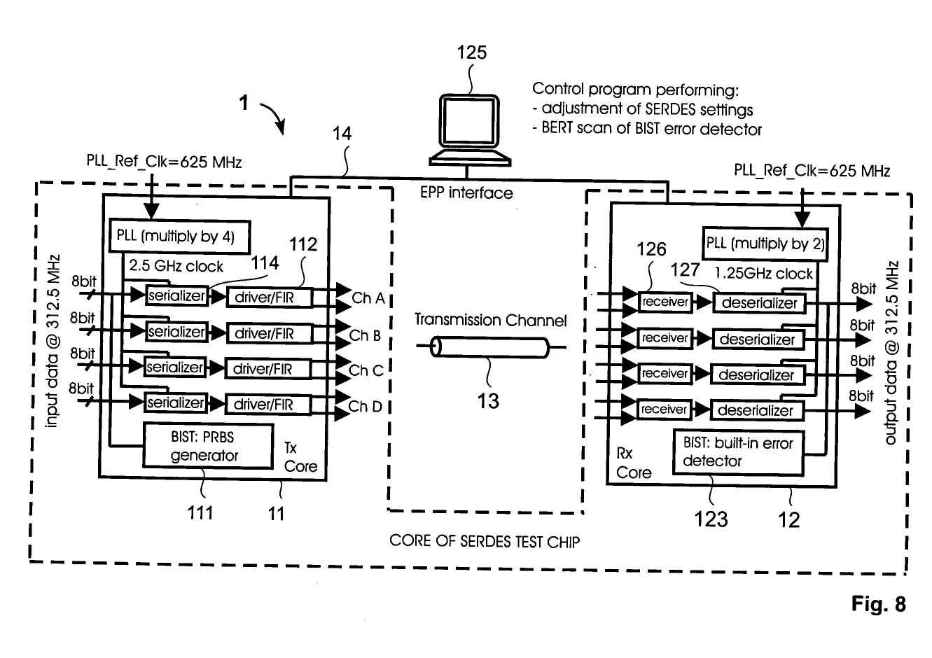

FIG. 8 introduces a serial link setup 1 comprising parallel optical devices driven by a so called SERDES (Serializer-Deserializer) test chip where serializer and deserializer functions are implemented. The parallel optical devices are standard electro-optical transceiver modules interconnected by a fiber ribbon cable as transmission channel 13. A single module has twelve links and is operated in the present serial link setup at 2.5 Gbps. The test chip is implemented as a set of ASIC cores that allow serial communication across wired media for use as chip-to-chip and card-to-card interconnects. It has eight cores with four links each and can be operated at data rates between 2.1 and 3.125 Gbps. The schematic of a single ASIC core is shown in FIG. 8, including a sender 11 and a receiver 12, each serving four channels A to D. In the sender 11, there is a serializer unit 114 and a pre-eniphasis unit 112 associated to each channel, whereas in the receiver 12, there is a receiver block 12b and a deserializer unit 127 associated to each channel. A back channel 14 is designed for sending information from the receiver 12 to the sender 11.

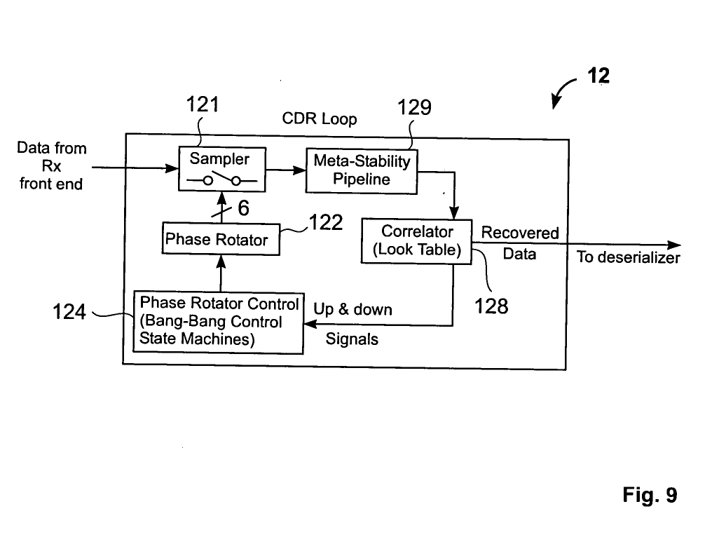

In this embodiment, the key component for jitter measurements is a digital clock-data-recovery (CDR) loop for recovering clock and date, the clock-data-recovery loop being a virtual part of the receiver 12 and in particular of each receiver block 12b. A more detailed schematic of the digital clock-data-recovery loop receiver is depicted in FIG. 9. The clock-data-recovery loop works as follows: First, the data received is over-sampled three times in a sampling unit 121 and fed through a meta-stability pipeline 129. The samples are taken by equally spaced phases of a phase rotator 122 that can adjust its reference phase in discrete phase steps based on control signals from a control unit 124 CDR. Next, the samples are compared with some predefined sample patterns in the lookup table of a correlator 128 to decide whether the point of time of the reference sample occurred too early or too late with respect to the actual sampled data-edge positions. Based on this decision, the correlator 128 outputs up and down signals indicating that the reference-sample point of time needs to be increased or decreased during the next sampling phase. The correlator 128 also reconstructs the data bits by selecting the middle samples and transfers the recovered bits to the protocol layer. The up and down signals from the correlator 128 are used as control signals for the phase rotator 122, which determines the sampling points of time and thus closes the clock-data recovery loop.

However, if the correlator's up and down signals were used directly for updating the reference phase in the phase rotator 122, the clock-data-recovery loop would have to track the sampled data edges instantaneously, even if they were heavily affected by jitter. Such a highly under-damped behavior would deteriorate the bit error rate performance of the serial link 1. In order to prevent the clock-data-recovery loop from tracking jitter too fast, the correlator's output signal is first filtered by a bang-bang control implemented in the control unit 124 prior to producing control signals for the phase rotator 122. The bang-bang control averages the up and down signals from the correlator 128 and determines, together with the phase-rotator slope, the clock-data-recovery loop bandwidth. The Optimum choice for the clock-data-recovery loop bandwidth strongly depends on the jitter of the incoming data signal, and thus an adaptive adjustment of the averaging factor is required. Accordingly, much importance is attached to the filtering algorithm running in the bang-band control as this affects the link's bit error rate performance and the time until the clock-data-recovery loop is locked.

As shown in the schematic of FIG. 8, the sender/receiver cores 11, 12 on the test chip also provide built-in self-test (BIST) functions including a pseudo-random bit sequence generator 111 in the sender core 11 and an error detection unit 123 in the receiver core 12. Additionally, the sender 11′ comprises the pre-emphasis units 112 each implemented as a four-tap finite-im ulse-response (FIR) filter to compensate for the roll-off of the transmission-channel frequency response. The bit pattern sequence generator 111, the error detection unit 112 and the pre-emphasis units 113 are important for applying the bit error rate scan technique that is key to the present embodiment of the invention.

The test chip shows an interface for being monitored by a control program running on a PC that serves inter alia as evaluation unit 125. The control program allows access to the built in self test registers of each ASIC core. Of particular importance in this context is the option of enabling the built in self test functions for reading the bit error rate of the built-in error detector and adjusting the weights of the FIR taps. Other important settings that can be accessed at runtime by the control software are the manual adjustment of the phase rotator 122, the PLL tuning and the driver power in the transmit cores 11.

The bit error rate for the bathtub curve plot can be read from the built-in error detection unit 123. Result is a bathtub curve fit obtained by the bit error rate scan. The phase-step resolution of the error detection unit 123 is in this example 720°/54 steps ˜13°/step.

According to this embodiment, in the pre-emphasis FIR unit 112 tap weights can be adjusted by the control program that is run on the PC. The task of this control program could also be taken over by the chip's digital control part. The control program allows an automated bathtub curve fit procedure by sweeping the most significant tap weight from zero to its maximum value and simultaneously measuring bathtub curves with the internal error detection unit 123. The measurement automation also includes the evaluation of the measurement results with respect to the horizontal eye opening at a bit error rate boundary of 10⁻¹².

The principle of finding optimum pre-emphasis settings based on bathtub curve measurements can also be extended to other parameters such as PLL settings or the adjustment of the driver power because all these settings effect the horizontal eye opening.

The parameter optimization exhibits three major advantages: (1) the procedure is directly based on the bit error rate, which is the most important measure for the link performance; (2) an individual optimization of parameters that affect the jitter generation can easily be implemented without increasing the analytical complexity, and (3) the optimization algorithm of the bit error rate scan data can be shared among a large number of serializer-deserializer ASIC cores operated in parallel.

A fast extraction of the information contained in the bathtub curve edges in a bit error rate range of 10⁻⁵ to 10⁻⁹. This can be done and is covered, for instance, by performing the bit error rate scan measurement only at some few sampling points of time where the expected bit error rate is well within the bathtub curve edge (e.g. at bit error rate=10⁻⁷). Next only the parameter that is to be optimized is swept while the bit error rate is always measured at the few same sampling points of time.

As discussed above, the equalization method as proposed here is based on enabling a bit pattern sequence generator at a serializer-deserializer sender and performing a bit error rate scan in the receiver. The bit error rate scan yields a bathtub curve that can be characterized by at least a characteristic figure, also called quality value which can be considered as jitter numbers obtained by an automatic bathtub curve fit. The pre-emphasis unit settings of the sender are then swept from ‘no pre-emphasis’ to ‘highest level of pre-emphasis’ and the associated quality values from the bit error rate scan over an unit interval are recorded. Finally the recorded quality values are analyzed in order to find the lowest jitter number and the corresponding pre-emphasis setting which as a result is the setting for best equalization is adjusted at the transmitter and causes the largest eye opening. After this operation the bit pattern sequence generator is disabled and the serial link returns to its normal operation, however now with optimally adjusted tap weights of the pre-emphasis unit.

As an embodiment of the present invention, a way for adjusting pre-emphasis settings can be described by the following steps:

(1) Sweep the FIR tap-weights from the setting ‘no pre-emphasis’ to ‘highest level of pre-emphasis’

(2) Enable the bit pattern sequence generator in the sender

(3) Perform a bit error rate scan of the error detection unit in the receiver

(4) Fit the bathtub curve (automatically) and record the fitted RJ and DJ numbers

(5) Repeat step (3) & (4) for all possible pre-emphasis settings

(6) Find the minimum of RJ and DJ numbers and adjust the FIR tap settings to the pre-emphasis setting that corresponds to these minimum jitter numbers (=Optimally equalized eye at the receiver)

(7) Disable the bit pattern sequence generator and return to normal operation

These steps could be implemented by a program causing the actions mentioned in steps (1) to (7) to be executed, and e.g. run on the evaluation unit 125 according to FIG. 8.

Compared to conventional equalization methods the proposed method shows the following advantages: The equalization ‘algorithm’ could easily be extended for other settings (e.g. PLL settings, driver power settings, and might not only be restricted to the FIR tap settings that may impact the eye opening at the receiver. Insofar, the term equalizer unit extends also to any such adjustable components in the sender or the receiver that allow to equalize the transmission loss, nevertheless whether such components primarily fulfill other tasks such as power supply. The equalization evaluation algorithm can also be run off-chip and so it could be shared by many other I/O cores of a customer ASIC.

Typical Beauregard Claims

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after conversion to another language, code or notation and/or reproduction in a different material form.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1. A method for adjusting parameters of a serial link, comprising:
receiving a bit pattern sequence transmitted via a transmission channel of the serial link,
sampling the bit pattern sequence at different sampling times,
determining bit error rate values for corresponding sampling times, the bit error rate values resulting in a curve, and
determining a quality value derived from the curve, the quality value being used for adjusting equalizer parameters of an equalizer unit.

2. A method according to claim 1, comprising
determining quality values associated to different sets of equalizer parameters, and
determining a preferred quality value out of the determined quality values.

3. A method according to claim 2, comprising
determining the preferred quality value in an initialization phase, and
adjusting the equalizer parameters according to the set of equalizer parameters that is associated to the preferred quality value for a data transmission phase.

4. A method according to claim 1,
wherein the curve generated by the bit error rate values shows bathtub characteristics, and
wherein the quality value is represented by a horizontal distance between the falling sections of the bathtub curve at a predetermined error rate value.

5. A method according to claim 1, wherein the samples are taken directly on a receiver's chip.

6. A method according to claim 1, wherein the bit error rate values are determined by a corresponding function implemented on a receiver's chip.

7. A method according to claim 1,
wherein the bit pattern sequence is sampled at different sampling times across a unit interval, and
wherein the bit error rate values as determined result in a curve across the unit interval.

8. Computer program element comprising computer readable program code, executable by a digital processing unit to perform a method according to claim 1.

9. A serial link, comprising
a sender, the sender comprising a bit pattern sequence generator for generating a bit pattern sequence,
a transmission channel for transmitting the bit pattern sequence to a receiver,
the receiver comprising
a sampling unit for sampling a received bit pattern sequence,
a phase rotator for defining a sampling time,
an error detection unit for determining a bit error rate value for an associated sampling time,
a control unit for making the phase rotator sweep the sampling time across an unit interval and causing the error detection unit to determine bit error rate values for different sampling times,
an equalizer unit for adjusting the bit pattern sequence according to parameters, and
an evaluation unit for determining a quality value that is used for adjusting the parameters, the quality value being derived from a curve, the curve being determined by the bit error rate values.

10. A serial link according to claim 9, comprising
a back channel from the receiver to the sender, and
in the sender: the equalizer unit,

11. A serial link according to claim 9, wherein the evaluation unit is designed for determining a preferred quality value out of a plurality of quality values, each quality value being associated to a different set of parameters at the pre-emphasis unit.

12. A serial link according to claim 11, comprising in the evaluation unit: a trigger unit that is configured for causing a particular set of parameters to be applied at the equalizer unit for a data transmission phase, the particular set of parameters being associated to the preferred quality value.

13. A serial link according to claim 9,
wherein the sampling unit and the phase rotator are arranged on a receiver's chip.

14. A serial link according to claim 9,
wherein the error detection unit is arranged on a receiver's chip.

15. A serial link according to claim 9, comprising in the receiver: the control unit and/or the evaluation unit.

16. A serial link according to claim 15, wherein the control unit and/or the evaluation unit are arranged on a receiver's chip.

17. A receiver of a serial link, the receiver comprising features according to the receiver as claimed in claim 15.

18. An article of manufacture comprising a computer usable medium having computer readable program code means embodied therein for causing adjustment of parameters of a serial link, the computer readable program code means in said article of manufacture comprising computer readable program code means for causing a computer to effect the steps of:
receiving a bit pattern sequence transmitted via a transmission channel of the serial link,
sampling the bit pattern sequence at different sampling times,
determining bit error rate values for corresponding sampling times, the bit error rate values resulting in a curve, and
determining a quality value derived from the curve, the quality value being used for adjusting equalizer parameters of an equalizer unit.

19. An article of manufacture as recited in claim 18, the computer readable program code means in said article of manufacture further comprising computer readable program code means for causing a computer to effect:
determining quality values associated to different sets of equalizer parameters, and
determining a preferred quality value out of the determined quality values.

20. An article of manufacture as recited in claim 18, the computer readable program code means in said article of manufacture further comprising computer readable program code means for causing a computer to effect:
determining the preferred quality value in an initialization phase, and
adjusting the equalizer parameters according to the set of equalizer parameters that is associated to the preferred quality value for a data transmission phase.

21. A computer program product comprising a computer usable medium having computer readable program code means embodied therein for causing functions of a serial link, the computer readable program code means in said computer program product comprising computer readable program code means for causing a computer to effect:
a sender, the sender comprising a bit pattern sequence generator for generating a bit pattern sequence,
a transmission channel for transmitting the bit pattern sequence to a receiver,
the receiver comprising
a sampling unit for sampling a received bit pattern sequence,
a phase rotator for defining a sampling time,
an error detection unit for determining a bit error rate value for an associated sampling time,
a control unit for making the phase rotator sweep the sampling time across an unit interval and causing the error detection unit to determine bit error rate values for different sampling times,
an equalizer unit for adjusting the bit pattern sequence according to parameters, and
an evaluation unit for determining a quality value that is used for adjusting the parameters, the quality value being derived from a curve, the curve being determined by the bit error rate values.
